(19) United States
(12) Patent Application Publication
(10) Pub. No.: US 2025/0129311 A1
(43) Pub. Date: Apr. 24, 2025

(54) ENCAPSULATED ENZYME IN SURFACTANT SYSTEM FOR HOME CARE APPLICATIONS

(71) Applicant: GALAXY SURFACTANTS LTD., Navi Mumbai (IN)

(72) Inventors: Vaijanath Kulkarni, Navi Mumbai (IN); Sagar Anil Trailokya, Navi Mumbai (IN); Vaishali Amol Jumde, Navi Mumbai (IN); Sneha Shailesh Ghadigaonkar, Navi Mumbai (IN)

(21) Appl. No.: 18/891,560

(22) Filed: Sep. 20, 2024

(30) Foreign Application Priority Data
Oct. 19, 2023 (IN) 202321071293

(51) Int. Cl. C11D 3/386; C11D 1/12; C11D 1/22; C11D 1/29; C11D 1/83; C11D 1/94; C11D 3/04; C11D 3/12

(52) U.S. Cl. CPC C11D 3/38672; C11D 1/12; C11D 1/22; C11D 1/29; C11D 1/83; C11D 1/94; C11D 3/046; C11D 3/1213; C11D 3/124; C11D 3/38609; C11D 3/38627

(57) ABSTRACT

Provided herein are enzyme granules where the enzyme is encapsulated within a surfactant system. The enzyme granules contain 80-90% of active and functional ingredients and less than 15% fillers. The enzyme granules are easy to prepare, safe to handle and have a long shelf life. These granules can be used in detergent compositions which have various home care applications.

### TECHNICAL FIELD OF THE INVENTION

The present invention relates to granules of enzyme encapsulated in surfactant system and its performance in home care applications. Particularly, the present invention relates to granules comprising enzyme/s surrounded by surfactant system and their use in detergents. More particularly, it relates to highly functional, stable granules with enzymes for detergent powder for homecare applications and process for preparation thereof.

### BACKGROUND AND PRIOR ART

It has been known for a long time that enzymes play an important role in soil and stain removal and hence are used in cleaning compositions or detergents. However, stability of enzymes in the cleaning system and optimum dosage of desired active components is a challenge.

WO 99/37746 discloses a multi-layer detergent tablet. It teaches the use of protective coating over enzymes is to improve storage stability of the enzyme when the granules are added to detergent. However, this adds the load of non-functional ingredients into cleaning system.

Similarly, U.S. Pat. No. 9,107,433 B2 discloses that stability of enzyme in detergent powder can be improved with the help of coating of an enzyme by using various ingredients such as reducing agent, multivalent cation, acidic buffer and salt coating to the core. However, the stability comes along with unnecessary loading the inactive components in the composition.

U.S. Pat. No. 6,350,728 B1 mentions that nonionic surfactant bonded with enzyme failed to show significant stability improvement. Converting enzymes into desired particles with the help of carrier systems was tried and tested but did not show desired solubility properties. The undissolved particles can surface during washing, get deposited on the clothes or are wasted.

WO93/07263 relates to enzyme containing granules consisting of water soluble or water dispersible core coated with a vinyl polymer which may also content pigments. Reproducing such multilayer structure can have its own challenges.

WO 95/02031 describes enzyme granules coated with water insoluble material such as fatty alcohol. Since the emulsifier is often not sufficient to dissolve the organic components, such types of enzyme granules can lead to residue problems when dissolved in water.

WO 93/07260 discloses a process to produce dust free enzyme granules, which comprises spraying a formation broth into a hydratable carrier material, spraying on a solution of certain coating materials, including fatty acid esters, alkoxylate in alcohols, polyvinyl alcohol, polyethylene glycol, sugar and starch and further evaporating solvent. The coating material used for the outermost layer are normally applied to the enzyme granules in the form of an aqueous dispersion in a fluidized bed dryer.

However, it results in destruction of the surface of the granules by dust abrasion. Which leads to an increased % of extremely fine particles. Because of their ununiform distribution and very small size, they are unsuitable for incorporation in the cleaning compositions.

Moreover, the use of coating material in dissolved form is a disadvantage because the solvent removal demands a separate step.

Presently available granules in the market are having coating or layer of various non-functional ingredients such as salt, sodium sulfate, silica, zeolite, starch, cellulose which do not contribute in cleaning action. The incorporation of such non-functional ingredients also reduces the amount of active components in the composition.

These granules of enzyme added to detergent powder, which further causes considerable reduction in activity of detergents, especially in the presence of bleaching compound/s.

Moreover, the high temperature treatment during formulation process, incompatibility with other components and long storage cause most of the enzymes degrade rendering poor performance of the cleaning composition.

Hence, there is need to develop solid enzyme granules with shelf-life stability, quick disintegration in water, not sensitive to moisture, safe to handle without any additional protective measures with uniform particle size.

The inventors of the present invention have overcome all the limitations of the prior arts and rendered a solid cleaning system having enzyme encapsulated in the surfactant system.

### Objective of the Invention

It is an objective of the present invention to provide granules of enzyme/s with surfactant system having maximum functional components and less than 10% fillers or nonfunctional ingredients.

It is another objective of the invention to create a cold processable cleaning system with enzyme encapsulated in surfactant system.

Yet another objective of the invention is to eliminate all the handling, dusting hazards experienced in incorporating solid enzymes in detergents.

Yet another objective of the invention is to overcome the degradation and stability issues of enzymes used in the cleaning system.

### SUMMARY OF THE INVENTION

Accordingly, the present invention provides a solid cleaning system for home care applications comprising enzyme encapsulated with surfactant system. The cleaning composition of the present invention is cold processable hence energy saving and is formulator friendly, it contains high amount of active ingredients and exhibits high stability.

In an aspect, the present invention provides granules comprising an enzyme surrounded by surfactants system and their use in detergents.

The present invention discloses solid granules having enzyme/s encapsulated with surfactant system, stable during shelf life, Safe to handle and does not require special protection measures.

In an aspect there is provided a cleaning system in the form of solid granules for home care applications, comprising of:
a. 80-90% by weight of a surfactant system comprising one or more surfactants;
b. 5-15% by weight of one or more enzymes;
c. 0-8% by weight of coatings or fillers; and
d. 5-10% by weight of sodium sulphate, wherein the one or more enzymes is encapsulated by the surfactant system.

The encapsulated granules of the present invention when incorporated into detergent powder demonstrate high stability of enzymes, synergistic behavior with surfactants hence significantly improved performance with same dosage (of current enzymes), at par performance with 25% less dosage of active surfactants and without dusting hazards due to selective particle size and good storage stability.

In another aspect, the core of granule may be single enzyme or mixture of enzymes and encapsulated with another functional ingredient such as surfactant from the group of anionic, nonionic, amphoteric surfactants. The encapsulating surfactant may be a single surfactant or combination of surfactants.

A solid cleaning encapsulated granules system of the present invention for home care has application in various home care domains such as laundry, dishwash, hard surface cleaning, industrial and institutional cleaning etc.

In another aspect, the inventors of the present invention have designed a safe, industrial friendly process for preparing the cleaning composition. The process of present invention rendering surfactant granules holding enzymes in the core is cold processable hence is energy saving and avoids all the dust handling hazards.

In another aspect there is provided a process of preparation of granules of cleaning system of the present invention; comprising steps of:
a. Mixing of solid surfactants, liquid enzyme/s and sodium sulphate powder without heating, to get homogeneous material;
b. Extruding the mass of step (a) through needler;
c. Converting the needles of step (b) into granules through spheronizer and
d. Adding silica to the granules.

### BRIEF DESCRIPTION OF ACCOMPANYING DRAWINGS

FIG. 1 illustrates the SEM image of the cross section of (a-b) enzyme granules-NVZ and (c-d) enzyme granules of the present invention.

### DETAILED DESCRIPTION OF THE INVENTION

The present invention provides a solid cleaning system for home care applications comprising enzyme encapsulated within a surfactant system. The cleaning system of the present invention is cold processable hence energy saving and is formulator friendly, it contains high amount of active ingredients and exhibits high stability.

The solid cleaning system is in the form of granules. The granules of the present invention comprising enzyme/s surrounded by surfactants system find applications in home care such as detergents, conditioners and hard surface cleaners.

A cleaning system with enzyme comprises the enzyme and the anionic/amphoteric/nonionic/cationic surfactant system and it may also comprise drying agent such as silica or sodium sulfate or both. Unlike the other enzyme granules, enzyme is encapsulated with surfactant and not fillers.

In the other embodiment, the encapsulated granules of the present invention when incorporated into detergent powder demonstrate high stability of enzymes, synergistic behavior with surfactants hence significantly improved performance with same dosage, at par performance with 25% less active and dry mixing without dusting due to selective particle size and good storage stability.

Solid granules comprising enzyme encapsulated in surfactant system for home care applications comprises of:
a. 80-90% by weight one or more surfactant;
b. 5-15% by weight of one or more enzymes;
c. 0-8% by weight of coatings or fillers and
d. 5-10% by weight of sodium sulphate.

Unlike the granules present in the market or as mentioned in the prior arts; the inventors of the present invention have designed the granule system wherein enzymes are encapsulated in surfactants. The total content of the surfactant (functional ingredient) is 80-90% by weight of the total granule system and the non-functional components is less 15% by weight of the total granule system.

In another embodiment of the invention, the inventors of the present invention have overcome the challenges to make a stable cleaning system with enzyme, without forming a lumpy texture due to moisture.

Enzymes have been used in detergents for their actions on stain removal from the fabric. However, incorporation of solid enzymes into detergent system is a big challenge as during solidification of enzyme, it has to go through heat treatment which causes deterioration of the expensive enzymes which inadvertently reflect in the performance. Moreover, formulating detergents with solid enzymes brings in handling hazards.

The process designed by the inventors of the present invention is energy saving, industrial friendly and eliminates all handling and dusting hazards encountered in dealing with solid detergents comprising enzyme system.

The cleaning system of the present invention with enzyme is prepared by using one or more surfactants wherein one or more liquid enzyme is mixed with solid surfactant/s without employing heat treatment.

The surfactant system for enzyme granules can be selected from anionic surfactants, cationic surfactants, amphoteric surfactants, nonionic surfactants.

The granules are stable at 5 to 40 deg. C.

A process of preparation of granules of cleaning system of the present invention; comprising steps of:
a. Mixing of solid surfactants, liquid enzyme/s and sodium sulphate powder without heating, to get homogeneous material;
b. Extruding the mass of step (a) through extruder/needler;
c. Converting the needles of step (b) into granules through spheronizer and
d. Adding silica to the granules,
   Wherein, no heat treatment is provided in any of steps.

### Core:

The core of the granule comprises an enzyme or mixture of enzymes which is a homogeneous blend of enzymes. The enzymes are selected from the group consisting of an amylase, a carbohydrate, a protease, a lipase, a cellulase, an oxidoreductase, a mannanase, or a pectate lyase.

Preferably, enzymes are selected from protease, amylase, lipase, cellulase, mannanase and the mixtures thereof.

In the granule system the enzymes are present in 5-15% by weight.

### Encapsulation Material:

In the granules of present invention, the enzymes are encapsulated in a surfactant system.

The surfactant system can be a single surfactant or combination of surfactants selected from anionic surfactants, cationic surfactants, amphoteric surfactants, and nonionic surfactants.

The surfactants are selected from Fatty alcohol sulphates, Ether Sulphates, Amino Acid surfactants, Fatty alcohol Ethoxylates, Various Betaines, Sulphosuccinates, LABS, AOS, such as sodium lauryl sulfate (SLS), Sodium lauroyl Taurate, Sodium Cocoyl sulfate, Sodium cocoyl glycinate (SCG), linear alkyl benzene sulfonic acid (LABSA), alfa olefin sulfonate (AOS), sodium lauryl sarcosinate (NaLS), sodium Cocoyl isethionate (SCI), sodium cocoyl taurate, cocoamidopropyl betaine, Sodium Lauryl Sulphosuccinates, Sulphobetains, lauryl alcohol (7-9) moles (ETLA), Benzalkonium chloride, Esterquats and the like.

The encapsulated granule comprises 80-90% by weight of surfactant system.

The surfactant system encapsulates the core unit by forming a substantially continuous layer. A substantial continuous layer is to be understood as a coating having few or no holes.

### Other Ingredients:

Optionally, the granule may include an additional coating of silica on the outside. The silica may be present in 0 to 8% by weight of the granule.

The additional coating material may comprise polyethylene glycol, hydroxyethyl methyl cellulose, polyvinyl alcohol, polymer/s, solid fillers, anti-sticking agents, pigments, dye, plasticizers and the like.

Other additional coatings on the outside of the surfactant encapsulation may be applied as known for people skilled in the art.

A solid cleaning encapsulated granules system of the present invention for home care has application in various home care domains such as laundry, dishwash, hard surface cleaning, industrial and institutional cleaning etc.

### Process of Encapsulated Enzyme Granule Preparation:

Granules of even size (200 to 1000 micron), without dusting, were prepared by mixing liquid enzyme and surfactant/s and processed with needler, granulator, spheronization or high shear granulation as step wise procedure shown below:

A process of preparation of granules of cleaning system of the present invention; comprising steps of:
a. Mixing of solid surfactants, liquid enzyme/s and sodium sulphate powder without heating, to get homogeneous material;
b. Extruding the mass of step (a) through Extruder/needler;
c. Converting the needles of step (b) into granules through spheronizer and
d. Adding silica to the granules.

Encapsulated granulation process started with cold mixing of—solid surfactants with liquid enzyme/s and further extruded through needler without heating. The needles loaded on spheronizer and produced granules of even size.

The process for preparation of granules of the present invention is very simple, eco-friendly, requires no heat treatment hence energy saving. There is no temperature, vacuum or pressure applied. Also, time of mixing is depended on batch size.

Table 1 gives a general representation of granules of the present invention.

TABLE 1
Surfactant granules comprising enzyme encapsulated in surfactant system

| Ingredients | Typical range (dosage % w/w) |
|---|---|
| Liquid Enzyme mixture | 5 to 15 |
| Na₂SO₄ | 5 to 10 |
| Anionic surfactant | 80 to 90 |
| Nonionic surfactant | 80 to 90 |
| Amphoteric surfactant | 80 to 90 |
| Cationic surfactant | 80 to 90 |
| Silica | 0.0 to 8 |
| Particle size | Particle Size 100-2000 Micron, >98% |

The granules comprising enzyme encapsulated in surfactant system as depicted by Table 1, may contain one or more surfactants in 80-90% by weight of granule compositions. The surfactants can be selected from one or more of anionic, cationic, amphoteric and non-ionic surfactants.

In one embodiment, the enzyme granules comprise of a surfactant system comprising sodium lauryl sulphate. In another embodiment, the enzyme granules comprise a surfactant system comprising sodium lauryl taurate. In a further embodiment, the enzyme granules comprise of a surfactant system comprising sodium lauryl sulphate and Coco amido propyl betaine. In yet another embodiment, the enzyme granules comprise of a surfactant system comprising sodium lauryl sulphate and ETLA 7 mole. In another embodiment, the enzyme granules comprise of a surfactant system comprising sodium lauryl taurate, ETLA 9 mole and Benzalkonium chloride.

The granules of the cleaning system as described herein find use in several home care applications. The home care applications may include but not limited to fabric care, fabric conditioner, hard surface cleaners including utensil cleaners, table-top cleaners, floor cleaners, bathroom cleaners etc.

### Detergent Powder Composition:

The granules can be formulated into a detergent composition.

The detergent composition may for example be formulated as a laundry detergent formulation for hand or machine wash including a cleaning additive suitable for pretreatment of stained fabrics or fabric softener formulation or detergent powder formulation for general use in household hard surface cleaning operations, formulations for hand and machine dishwashing operations.

Detergent composition may be in the format of powder, capsule, tablet, bar or granules. It may be non-aqueous liquid.

Generally, detergent powder composition contains:
Surfactants: Fatty alcohol sulphates, Ether Sulphates, Amino Acid surfactants, Fatty alcohol Ethoxylates, Various Betains, Sulphosuccinates, LABS, AOS, (such as sodium lauryl sulfate, sodium Cocoyl sulfate, linear alkyl benzene sulfonic acid (LABSA), alfa olefin sulfonate (AOS), sodium lauryl sarcosinate, sodium Cocoyl isethionate, sodium cocoyl taurate, cocoamidopropyl betaine, Sodium Lauryl Sulphosuccinates, Sulphobetains, lauryl alcohol (7-9) moles (ETLA).
Builders: Zeolite, triphosphate, phosphonate, carbonate, citrate, silicates
Co-builders: Homo polymers of polyacrylate, copolymers, EDTA, DTPA, GLDA etc.
Fillers: sodium sulfate, silica
Polymers: anti redepositing polymers, carboxy methyl cellulose. Hydroxypropyl methylcellulose etc
Optical brightener: UV filters such as 2,2′-([1,1′-Biphenyl]-4,4′-diyldi-2,1-ethenediyl) bis-benzenesulfonic acid disodium salt Tinopol CBSX, DMS-X-etc. 2,2′-([1,1′-Biphenyl]-4,4′-diyldi-2,1-ethenediyl)bis-benzenesulfonic acid disodium salt
Coloring agents: water soluble dyes and pigments
Bleaching System: sodium perborate, sodium percarbonate
Hydrotropes: sodium benzene sulfonate, sodium toluene sulfonate, sodium cumene sulfonate, polyglycol ethers etc.
Fragrances: suitable fragrance from single or combination of ingredients can be added optionally.

Apart from the conventional components, the detergent composition as provided herein will contain the granules comprising encapsulated enzymes in a surfactant system.

### EXAMPLES

The present invention is now described by way of working non-limiting illustrative examples. These examples are provided for illustrative purposes only and are not intended to limit the scope of the invention.

Liquid enzymes are procured from AETL, Mumbai; surfactants, such as anionic surfactants, amphoteric surfactants, non-ionic surfactants, cationic surfactants and sodium sulfate are produced inhouse at Galaxy Surfactant Ltd., Navi Mumbai; silica is procured form Madhu silica, Gujarat; colouring agents procured from Neelicon, Mumbai.

### Examples 1-9: Granules

Several granules have been formulated in accordance with the present invention.

TABLE 2
Examples of enzyme encapsulated granules with different surfactants system

| Sr | | Ex. | Ex. | Ex. | Ex. | Ex. | Ex. | Ex. | Ex. | Ex. | Non | Non |
|---|---|---|---|---|---|---|---|---|---|---|---|---|
| No. | Ingredients | 1 | 2 | 3 | 4 | 5 | 6 | 7 | 8 | 9 | working | working |
| 1 | Liquid | 10 | 10 | 5 | 10 | 10 | 10 | 10 | 0 | 0 | 10 | 10 |
| | Enzyme | | | | | | | | | | | |
| | mixture | | | | | | | | | | | |
| 2 | Na₂SO₄ | 10 | 7 | 5 | 6 | — | 3 | 3 | 5 | 5 | 5 | 5 |
| 3 | SLS | 75 | 80 | 85 | 84 | 87 | 80 | 80 | 85 | 85 | — | — |
| 4 | LA 7 mole | — | — | — | — | — | 5 | — | — | — | 80 | — |
| | EO | | | | | | | | | | | |
| 5 | CAPB | — | — | — | — | — | — | 5 | — | — | — | 80 |
| 6 | Silica | 5 | 3 | 5 | — | 3 | 2 | 2 | 5 | 5 | 5 | 5 |
| | powder | | | | | | | | | | | |
| 7 | Colouring | q.s. | q.s. | q.s. | q.s. | q.s. | q.s. | q.s. | q.s. | q.s. | q.s. | q.s. |
| | agent | | | | | | | | | | | |
| 8 | Lipase | 0 | 0 | 0 | 0 | 0 | 0 | 0 | 10 | 0 | — | — |
| 9 | Protease | 0 | 0 | 0 | 0 | 0 | 0 | 0 | 0 | 10 | — | — |
| | Total | 100 | 100 | 100 | 100 | 100 | 100 | 100 | 100 | 100 | 100 | 100 |
| A | Active % | 75 | 80 | 85 | 84 | 87 | 85 | 85 | 85 | 85 | 80 | 80 |
| B | Nature of | dry | dry | dry | dry | dry | sticky | sticky | dry | dry | Pasty, no | Pasty, no |
| | granule | | | | | | | | | | granulation | granulation |
| | | | | | | | | | | | feasible | feasible |

Table 2 demonstrated experiments conducted for enzyme encapsulated granules with different surfactants system, where in Liquid Enzyme mixture (Lipase, Amylase, Cellulose, Mannase, Protease) was added at 5 to 10% from exp. No. 1 to 7 and the non-working examples.

Sodium sulfate was added as filler from 3 to 10% on solid basis.

Example 1, 2, 3 and 4 studied for efficacy study of Anionic surfactant, SLS at dosage 75, 80, 85 and 84% respectively. The granule formation of experiment 4 was better compared to exp. 1, 2 and 3.

Silica powder was added to the coating to make granules harder.

Experiment no. 6 and 7 were conducted to study nonionic surfactant (LA 7 mole EO) and amphoteric surfactant (CAPB), where granules formed well but observed slightly sticky in nature with the given composition. Similarly, the non-working experiments were conducted with higher concentration of the nonionic and amphoteric surfactant. In these cases, even with increase in the concentration of surfactant, there is no granulation feasible. Further experiment no. 8 and 9 were performed to study individual enzyme incorporation effect on granulation and performance. Example 5 was prepared with Silica and without sodium sulfate and it was observed similar in physical appearance like experiment no. 4 granules-which was without silica and only with sodium sulfate. Experiment no. 4 and 5 are optimized granules selected for further study in detergent powder to check its performance and stability.

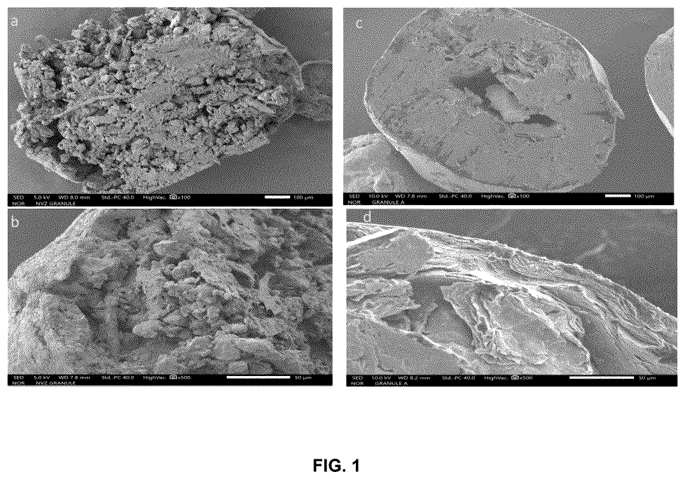

FIG. 1 shows a cross section view of an illustrative granule formed in the present invention in comparison with an enzyme granule-NVZ taken by a Scanning Electron Microscope (SEM). The enzyme granule-NVZ is an enzyme granule formed with enzymes encapsulated with inactive fillers unlike the present invention where the enzyme is encapsulated with surfactants that are active components.

The constitution of enzyme granules-NVZ is as follows:

Enzymes-Protease (Subtilisin), Alpha-amylase and Lipase

Formulation ingredients:

Sodium sulphate, Calcium carbonate, Cellulose, Polyethylene glycol, Kaolin, Titanium dioxide, Dextrin, Sucrose

The following Tables provide few specific compositions of enzyme granules with the surfactant system:

| Sr. | | % |
|---|---|---|
| no. | Ingredients | w/w |
| 1 | Sodium lauryl sulphate (anionic) | 80 |
| 2 | Liquid Enzyme comprising | |
| | Lipase, Amylase, Cellulase, Mannanase, Protease | 10 |
| 3 | Sodium Sulphate | 7 |
| 4 | Colour optional | q.s. |
| 5 | Silica | 3 |
| | Total | 100 |

| Sr. | | % |
|---|---|---|
| no. | Ingredients | w/w |
| 1 | Sodium lauroyl Taurate (Anionic) | 90 |
| 2 | Liquid Enzyme comprising | 7.5 |
| | Lipase, Amylase, Cellulase, Mannanase, Protease | |
| 3 | Sodium Sulphate | 0 |
| 4 | Colour optional | q.s. |
| 5 | Silica | 2.5 |
| | Total | 100 |

| Sr. | | % |
|---|---|---|
| no. | Ingredients | w/w |
| 1 | Sodium lauryl sulphate (Anionic) | 70 |
| 2 | Coco amido propyl betaine (Amphoteric) | 12 |
| 3 | Liquid Enzyme comprising | 8 |
| | Lipase, Amylase, Cellulase, Mannanase, Protease | |
| 4 | Sodium Sulphate | 5 |
| 5 | Colour optional | q.s. |
| 6 | Silica | 5 |
| | Total | 100 |

| Sr. | | % |
|---|---|---|
| no. | Ingredients | w/w |
| 1 | Sodium lauryl sulphate (Anionic) | 65 |
| 2 | ETLA 7 mole (Non-ionic) | 15 |
| 3 | Liquid Enzyme comprising | 8 |
| | Lipase, Amylase, Cellulase, Mannanase, Protease | |
| 4 | Sodium Sulphate | 7 |
| 5 | Colour optional | q.s. |
| 6 | Silica | 5 |
| | Total | 100 |

| Sr. | | % |
|---|---|---|
| no. | Ingredients | w/w |
| 1 | Sodium lauroyl Taurate (Anionic) | 70 |
| 2 | ETLA 9 mole (Non-ionic) | 4.5 |
| 3 | Benzalkonium chloride (cationic) | 5.5 |
| 4 | Liquid Enzyme comprising | 10 |
| | Lipase, Amylase, Cellulase, Mannanase, Protease | |
| 5 | Sodium Sulphate | 5 |
| 6 | Colour optional | q.s. |
| 7 | Silica | 5 |
| | Total | 100 |

### Examples 10-15: Detergent Powder Composition

The encapsulated enzyme granules are formed as per suitability of the Detergent composition. Size of granules and no dusting was specially considered, and safe handling was a key requirement for Hearth Surfactant system with enzyme granules. So that dusty powder materials/surfactants and enzyme handling can be eliminated during powder detergent processing.

TABLE 3
Laundry Detergent Powder composition with Surfactant system with enzyme granules

| | | | | | Ex. 13 | Ex. 14 | Ex. 15 |
|---|---|---|---|---|---|---|---|
| | | Ex. 10 | Ex. 11 | Ex. 12 | Comparative ex. | Market example | |
| Sr. No. | Ingredients | % w/w | | | | | |
| | Market sample(16% AM) | — | — | — | — | 72 | 70 |
| 1 | LABSA | 7.0 | 10.0 | 7.0 | 7.0 | — | — |
| 2 | Sodium Carbonate | 25.0 | 25.0 | 12.5 | 25.0 | 12.5 | 12.5 |
| 3 | Sodium percarbonate | 12.5 | 12.5 | 12.5 | 12.5 | 12.5 | 12.5 |
| 4 | Surfactant system with | 5.0 | 3.0 | 5.0 | — | 3 | 5 |
| | enzyme | | | | | | |
| 5 | Zeolite | 20.0 | 20.0 | 20.0 | 20.0 | — | — |
| 6 | CBSX | 0.15 | 0.15 | 0.15 | 0.15 | — | — |
| 7 | Sodium Citrate | 3.0 | 3.0 | 3.0 | 3.0 | — | — |
| 8 | Sodium Sulphate | 27.35 | 27.35 | 40.85 | 27.35 | — | — |
| 9 | Enzyme granules - NVZ | — | — | — | 1.0 | — | — |
| 10 | SLS granules | — | — | — | 5 | — | — |
| | Total | 100 | 100 | 100 | 100 | 100 | 100 |
| | % Active | 12 | 13 | 12 | 12 | 14.5 | 16.2 |
| | dE value = | 399 | 400 | 391 | 380 | 390 | 418 |
| | (post wash − pre- wash) | | | | | | |
| | CIE index = | | | | | | |
| | detergency performance | | | | | | |

Table 3 demonstrated three experiments (experiment no. 10, 11, and 12) of detergent powder having granules of encapsulated enzyme with surfactant system and one experiment of detergent powder (experiment No. 13) where surfactant and enzyme was added separately along with surfactant as LABSA, which was added at same dosage in exp. 10 or 12, and 13 as its comparative experiment. Experiment 13 uses enzyme granules-NVZ and SLS granules separately.

Experiment no. 13 is a comparative experiment for experiment no. 10 and 12, to provide inventive benefit of granules of encapsulated enzyme with surfactant system. dE value for experiment no. 10 and 12 is better than experiment no. 13. The detergency of experiment no. 10, 12 and 13 which is dE value shows 399, 391 and 380 respectively.

This confirms that granules of encapsulated enzyme with surfactant system enhanced performance compared to individual addition of surfactant and enzyme separately.

Market sample of detergent powder having activity 16% which is compared to experiment no. 14, where in 3% activity was replaced with granules of encapsulated enzyme with surfactant system and in experiment no. 15, where in 5% activity was replaced with granules of encapsulated enzyme with surfactant system. Total activity of all samples was 16%. The performance of samples was compared by detergency study dE, for Market sample it was 307, exp. No. 14, dE was 390 and exp. No. 15, dE was 418. Significant improvement in performance was observed.

### Granule Dissolution Time:

Marketed encapsulated granules NVZ dissolution time 1% in water is 3.30 min whereas enzyme encapsulated with surfactants granules of the present invention dissolution time 1% in water is 2 min. Significant difference in dissolution time is observed and this leads to impact/action on stains of fabric. Quick dissolution enhances cleaning efficiency.

### Test Protocol: Stability Study as Per Inhouse Developed Protocol

Stability study was conducted for detergent powder formulation having granules of enzyme encapsulated surfactant system with different dosage & LABSA as another surfactant active. Detergency study was conducted on six different fabric stains with the help of Laundrometer & UV spectrophotometer.
Wash cycle: 15 min.
Rinse cycle1: 15 min.
Rinse cycle2: 15 min.
Drying and measuring reflectance on UV spectrophotometer (Konica Minolta 3600A)
CIE 76 index was considered on fabric swatches prewash and post wash.
Postwash-Prewash values=dE (difference of stain removal).
The higher the dE, the better the stain removal.

If dE of 7^{th} day is >80% of performance of Oday/initial, then product/detergent powder and granules containing enzyme with surfactant system are stable.

Test protocol: Foaming (As per BIS No. IS 6047:2009)

Measuring cylinder of 250 mL to be filled with 50 mL 0.25% solution of detergent powder and with the help of hands strokes were given up and down. A total of 10 strokes for each sample and foam volume measured in ml as total foam volume.

### Test Protocol: Sieve Analysis/Fines Data/Particle Size Analysis (in House)

Granule sample of 100 g with known weight is passed through the series of various sieves starting form larger to smaller micron size.

Fines is known as dust which is not acceptable, hazardous, harmful for health and environment.

In regular granules of enzyme present in the market, more than 10% dust is observed whereas in the granules of enzyme with surfactant system of present invention, provides 99% granules and less than 1% dust.

TABLE 4
Stability of Enzyme granules & its stability in Detergent powder

| | Granules of encapsulated | Initial | | | |
|---|---|---|---|---|---|
| Sr. | enzyme with surfactant | activity | | | |
| No. | system | % (25° C.) | 5° C. | 25° C. | 40° C. |
| 1 | 0 day (Initial activity %) | 84.43 | — | — | — |
| 2 | 30^{th} Day (Activity %) | — | 84.18 | 84.17 | 83.86 |
| | Detergent powder (7% | dE = postwash − prewash CIE index | | | |
| | LABSA + 5% Surfactant | value (Total on 6 stains) | | | |
| | system with enzyme) | | | | |
| | | Initial | | | |
| | | (25° C.) | 5° C. | 25° C. | 40° C. |
| 3 | 0 day (Initial detergency as dE) | 391 | — | — | — |
| 4 | 7^{th} day (detergency as dE) | — | 396 | 390 | 393 |
| 5 | 15^{th} day (detergency as dE) | — | 389 | 384 | 390 |
| 6 | 30^{th} Day (detergency as dE) | — | 390 | 383 | 385 |

**5% standard deviation in the readings is expected and is not significant.

Table 4 demonstrates representative study for stability of enzyme granules & its stability in final composition. The experimental values confirm that the granules of encapsulated enzyme with surfactant system are stable after 30 days at 5° C., 25° C. and 40° C. there is no significant change in anionic activity of granules at initial Vs 30th Day.

Detergent powder prepared by using 7% LABSA and 5% granules of encapsulated enzyme with surfactant system was studied for 30 days stability by checking its detergency as dE (CIE index) Post wash value-Prewash value. Initial dE was observed 391 and post 30th day at three different temperature samples tested for detergency and observed with dE 390 for 5° C., dE 383 for 25° C. and dE 385 for 40° C. All dE values are greater than 90% of original dE values of detergent powder. Less than 80% dE values means instability and above it product is stable.

Hence, it is confirmed that detergent powder with granules of encapsulated enzyme with surfactant system is stable post 30 days stability.

### Example 16: Dishwash Formulation

| Sr. | | | |
|---|---|---|---|
| No. | Ingredients | Function | % w/w |
| 1 | Sodium carbonate | Alkaline Cleanser & builder | 25.0 |
| 2 | Sodium bicarbonate | Alkaline Cleanser & builder | 20.0 |
| 3 | Sodium sulfate | Filler | 38.5 |
| 4 | Sodium citrate | Water softener & builder | 5.0 |
| 5 | Sodium silicate | Binder | 2.5 |
| 6 | 7 mole Lauryl | Degreaser & emulsifier | 2.0 |
| | ethoxylate | | |
| 7 | Surfactant system | Cleansing and stain removal agent | 7.0 |
| | with enzyme | | |

Example 16 demonstrates a dishwash formulation having granules of encapsulated enzyme with surfactant system. This dishwash formulation ensures streak free and rapid cleaning & drying of utensils.

The formulation of example 16 is suitable for dish hand wash as well as automatic dishwasher and removes oil and soil from utensils effectively.

### Advantages of the Invention

The granule system of the present invention comprises of enzymes encapsulated by surfactant system (functional ingredient) in 80-90% by weight and minimizes the dosing of non-functional ingredients.

The granule system of the present invention is stable, high performing and non-sensitive to moisture form.

The process for preparation of granule system of the present invention eliminates handling and dusting hazards which are encountered while incorporating solid enzymes into detergent system.

The granule system of the present invention is prepared by cold process, hence the process is energy saving, formulator friendly.

1. A cleaning system in the form of solid granules for home care applications, comprising:
a. 80-90% by weight of a surfactant system comprising one or more surfactants;
b. 5-15% by weight of one or more enzymes;
c. 0-8% by weight of coatings or fillers; and
d. 5-10% by weight of sodium sulphate,
wherein the one or more enzymes is encapsulated by the surfactant system.

2. The cleaning system of claim 1, wherein the one or more surfactants are selected from anionic surfactants, cationic surfactants, amphoteric surfactants, and nonionic surfactants.

3. The cleaning system of claim 1, wherein the one or more surfactants are selected from sodium lauryl sulfate (SLS), Sodium lauroyl Taurate, Sodium Cocoyl sulfate, Sodium cocoyl glycinate (SCG), linear alkyl benzene sulfonic acid (LABSA), alfa olefin sulfonate (AOS), sodium lauryl sarcosinate (NaLS), sodium Cocoyl isethionate (SCI), sodium cocoyl taurate, cocoamidopropyl betaine, Sodium Lauryl Sulphosuccinates, Sulphobetains, lauryl alcohol (7-9) moles (ETLA), Benzalkonium chloride, and Esterquats.

4. The cleaning system of claim 1, wherein the one or more enzymes are selected from lipase, protease, cellulase, amylase, oxidoreductase, a mannanase, a pectate lyase, and a combination thereof.

5. The cleaning system of claim 1, wherein the coatings or fillers are selected from silica and TiO₂.

6. The cleaning system of claim 1, wherein particle size of the solid granules is in the range of 100-2000 micron for more than 98% of the particles.

7. The cleaning system of claim 1, comprising additives acceptable in home care compositions.

8. Home care compositions comprising the cleaning system of claim 1.

9. Home care compositions comprising the cleaning system of claim 8, wherein the home care compositions are selected from laundry, dishwash, industrial and institutional cleansing, and hard surface cleaning formulations.

10. A process of preparation of the cleaning system of claim 1, the process comprising the steps of:
a. mixing of one or more solid surfactants, one or more liquid enzymes and sodium sulphate powder without heating, to produce a homogeneous mass;
b. extruding the mass of step (a) through an extruder/needler to produce needles;
c. converting the needles of step (b) into granules through a spheronizer; and
d. adding silica to obtain the cleaning system granules,
wherein no heat treatment is provided in any of steps (a)-(d).

11. The cleaning system of claim 7, wherein the additives are selected from polyethylene glycol, hydroxyethyl methyl cellulose, polyvinyl alcohol, polymers, solid fillers, anti-sticking agents, pigments, dyes, and plasticizers.
